(19) United States
(12) Patent Application Publication
(10) Pub. No.: US 2023/0255220 A1
(43) Pub. Date: Aug. 17, 2023

(54) USE OF A PRESERVATIVE COMBINATION FOR REDUCING GROWTH OF GRAM NEGATIVE BACTERIA IN OR ON A MEAT PRODUCT

(71) Applicant: Niacet B.V., WC TIEL (NL)

(72) Inventors: Eelco Anthonius Johannes HEINTZ, WC TIEL (NL); Hendrik Jan VAN LENT, WC TIEL (NL); Peter Paul Jacobus Johannes LAMERS, WC TIEL (NL); Peter Harold BUCKLEY, WC TIEL (NL)

(73) Assignee: Niacet B.V., WC TIEL (NL)

(21) Appl. No.: 18/014,636

(22) PCT Filed: Jul. 6, 2021
(86) PCT No.: PCT/EP2021/068692

§ 371 Date: Jan. 5, 2023

(30) Foreign Application Priority Data
Jul. 7, 2020 (NL) 2026011

(51) Int. Cl. A23B 4/20; A23L 3/3508

(52) U.S. Cl. CPC A23B 4/20; A23L 3/3508

(57) ABSTRACT

The present invention relates to the use of a preservative combination for inhibiting growth of gram negative bacteria in or on a meat product. The invention also relates to a method for reducing growth of gram-negative bacteria in or on a meat product. The invention also relates to a meat product, treated with said preservative combination.

The present invention relates to the use of a preservative combination for inhibiting growth of gram negative bacteria in or on a meat product. The invention also relates to a method for inhibiting growth of gram-negative bacteria in or on a meat product. The invention also relates to a meat product, treated with said preservative combination.

The prevention of contamination of meat products by pathogens is important to protect public health.

Such pathogens include bacteria such as bacteria of the Enterobacteriaceae family, including E. coli and Salmonella. These bacteria, when present in meat may result in severe infections even if present in a low amount.

Therefore there is a need for improved methods of meat preservation.

The document Immediate Reduction of Salmonella enterica Serotype Typhimurium Viability via Membrane Destabilization following Exposure to Multiple-Hurdle Treatments with Heated, Acidified Organic Acid Salt Solutions, Milillo et al., Appl Environ Microbial. 2011 June; 77(11): 3765-377 suggests the use of organic salts accompanied with a heat treatment to reduce growth of Salmonella on poultry carcasses.

### DESCRIPTION OF THE INVENTION

The inventor has now surprisingly found that the use of a combination of propionate and acetate salts leads to a synergistic effect with regard to inhibition of growth of gram negative bacteria in or on a meat product when compared to the use of propionate or acetate alone. In this respect the inventor observed that treatment of meat with this preservative combination leads to an increased inhibition of growth compared to treatment with propionate or acetate alone. Furthermore, no additional steps such as heat treatment are required to achieve this synergistic effect. The synergistic effect in particularly relates to the prevention of growth of gram negative bacteria, which are important and often harmful contaminants of meat products. The synergistic effect came as a surprise as the synergistic effect was not observed in case Listeria, another common food pathogen, which is a gram positive bacterium. Without wishing to be bound by a theory the inventor considers that it is possible that the effects are due to differences in metabolism between gram positive and gram negative bacteria.

Therefore the present invention relates in one aspect to the use of a combination of sodium salts of propionate and acetate for inhibiting growth of gram negative bacteria in or on a meat product.

In a second aspect the invention relates to a method for inhibiting growth of gram-negative bacteria in or on a meat product, comprising treating said meat product with a combination of sodium salts of propionate and acetate; and testing for the presence of gram-negative bacteria in or on the meat product.

In a third aspect the invention relates to a meat product, treated with a combination of sodium salts of propionate and acetate.

In the present invention growth of gram negative bacteria is inhibited. In other words growth is reduced or even prevented by the treatment with a combination of propionate and acetate salts. That means that propagation of bacteria already present in or on the meat is inhibited compared to the situation wherein meat is not treated. Inhibition of growth may lead to a lower propagation rate, i.e. slower growth, or even in a decrease of the total amount of bacteria in or on the meat. On the other hand the treatment in accordance with the invention prevents bacteria from propagating. This relates to bacteria present in or on the meat before treatment (indigenous bacteria) but also to bacteria from outside sources after treatment of the meat. Especially in the latter case the invention serves a purpose of preventing bacterial contamination of the meat.

As a result, a meat product is obtained that has a longer shelf life and which is safer for consumption.

The invention relates in particular to the reduction or prevention of growth of gram negative bacteria, because the inventor has observed that the above mentioned synergistic effect with regard to prevention and reduction of bacterial growth applies for gram negative bacteria rather than gram positive bacteria.

An importance source of bacterial borne food poisoning and infections are the gram negative bacteria of the Enterobacteriaceae family. The invention is well suitable for prevention and reduction of bacteria of this family. It is therefore preferred that in the context of the present invention, the gram negative bacteria are bacteria of the Enterobacteriaceae family.

This family includes bacteria of the Salmonella genus. As shown in the examples below, particular good results were found with respect of prevention and growth of bacteria of the Salmonella genus. This genus includes for instance Salmonella enteritidis, Salmonella heidelberg, and Salmonella typhimurium. In a preferred embodiment therefore the gram negative bacteria in the context of the present invention comprise one or more of Salmonella enteritidis, Salmonella heidelberg, and Salmonella typhimurium. Examples of pathogenic strains in this respect are strains S. enteritidis 6424, S. enteritidis E40, S. heidelberg S13, S. typhimurium S9, and S. typhimurium M-09-0001-A1.

Other members of the Enterobacteriaceae family for which good growth preventive and growth reducing results were observed are Escherichia coli bacteria (E. coli), in particular shiga-toxin producing E. coli (STEC), which includes the enterohaemorragic E. coli (EHEC), such as strains selected from O111:H8, O103:H2, O121:H9, O45:H2, O145:NM, O26:H11, and O157:H7 and O104:H4 or mixtures thereof.

The meat product in the context of the invention may be a raw meat product or a processed meat product, such as a cooked meat product. This includes for instance cold cuts such as sliced hams. The above mentioned Salmonella and E. coli bacteria form an important problem in raw meat products, including fresh raw meat, such as minced meat, processed raw meat, mildly processed raw meat, unprocessed raw meat, fermented raw meat, such as fermented sausages. Therefore, in a suitable embodiment the meat product is a raw meat product, such as the raw meat products mentioned above.

The source of meat may be any meat source such as livestock. Suitable meats include pork, beef, poultry, such as chicken, turkey, etc.

Testing for the presence of gram-negative bacteria in or on the meat product may be carried out by any method known in the art for this purpose and may involve counts of colony forming units (CFU) and/or molecular biology techniques such as DNA or marker analysis, for instance PCR. The latter techniques may also be used for identification of the bacteria, if present. In view of the above the testing for the presence of gram-negative bacteria in or on the meat product comprises testing for the presence of bacteria of the Enterobacteriaceae family, in particular testing the presence of bacteria of the Salmonella genus, such as one or more of Salmonella enteritidis, Salmonella heidelberg, and Salmonella typhimurium, such as S. enteritidis 6424, S. enteritidis E40, S. heidelberg S13, S. typhimurium S9, and S. typhimurium M-09-0001-A1. Testing may alternatively or in addition comprise testing for the presence of Escherichia coli, such as STEC, EHEC, O111:H8, O103:H2, O121:H9, O45:H2, O145:NM, O26:H11, and O157:H7 and O104:H4 or mixtures thereof.

Further, in accordance with the invention, the propionate and acetate salts are in the form of sodium salts. Sodium salts are commonly used as food grade additives. The use of sodium salts in the context of the present invention has been found very suitable to provide the composition in a free flowing powder form, in contrast to other salts, such as potassium salts, so that the invention opens the possibility to provide the composition in powder form.

The inventor has also surprisingly found that because of the use of sodium salts of propionate and acetate further additives are in principle not required to obtain the desired effects with regard to preventing Gram negative bacterial contamination of the meat. In particular, where prior art potassium salt based solutions, such as disclosed for instance in EP 2 227 965 A1, US 2013/0171314 A1 require the presence of a large amount of potassium lactate, the present invention allows to achieve the desired effects with the sodium salts of acetate and propionate without further additives. This does not only save material, but in view of the fact that acetate and propionate do not affect the taste of meat, it also allows to prevent Gram negative bacterial contamination of the meat without affecting the taste.

The terms propionate and acetate may relate to mono or di propionate or acetate salts or mixtures thereof, preferably mono propionate or mono acetate salts.

The combination of salts is suitably provided in the form of a powder composition containing both salts before treating the meat.

The provision of a powder is advantageous in terms of stability, transportation and storage; and moreover, a powder may be applied onto or mixed with the meat directly.

In light of the above it is further preferred that said composition comprises no or essentially no lactate salts or further additives. Because it is advantageous to minimize taste effects as much as possible it is also preferred that the composition comprises essentially no further additives. In this respect in a preferred embodiment the composition consists of sodium salts of propionate and acetate.

The powder can be applied directly onto the meat or mixed directly with the meat in powder form. Applying the salts may suitably be performed by rubbing or mixing said combination of propionate and acetate salts. For instance a powder may be rubbed and mixing may be suitable in case of minced meat.

The weight ratio of propionate to acetate salts preferably ranges from 10:90 to 90:10. More preferably the portion of propionate salts exceeds the portion of acetate salts in weight, i.e. a weight ratio of more than 50:50.

This includes ratios of propionate to acetate between 50:50 to 90:10, such as 75:25 to 85:15. Suitable ratios in this respect are about 60:40 or about 80:20 or ratios in between.

The propionate and acetate salts should be added in an effective amount that leads to a reduction or prevention of bacterial growth and which does not have unacceptable effects on the taste and texture of the meat. Suitable amounts in this respect may be determined by the skilled person based without difficulty. For instance, for treatment of raw minced meat suitable amounts may range from 0.1 wt. % to 10 wt. % based on weight of the meat, such as between 0.2 and 1 wt. %, for instance about 0.25 wt. % or 0.5 wt. %.

### Examples

The following examples are included to demonstrate the synergistic effect of the combination of propionate and acetate salts and are not intended to limit the scope of the claims

A study was to determined growth inhibition and prevention of Listeria monocytogenes (as a comparative example of a gram positive bacterial species) and gram negative bacteria (Salmonella, STEC) as follows:

### 1. Salmonella/Escherichia coli

Portions of ground raw beef trim (target 80% lean) were inoculated separately with 4-4.5 log CFU/g Salmonella (S. enteritidis 6424, S. enteritidis E40, S. heidelberg S13, S. typhimurium S9, and S. typhimurium M-09-0001-A1) or Escherichia coli (including strains O111:H8, O103:H2, O121:H9, O45:H2, O145:NM, O26:H11, and O157:H7) by applying a 1% inoculum (v/w) into ground product and mixing for 5 minutes in a Hobart mixer (model A-200-D; Hobart Manufacturing Co., Troy, Ohio) to distribute the cells. Inoculated beef was held overnight at 4° C. to allow cells to acclimate to refrigeration temperatures.

Concentrated stock solutions of all antimicrobials were prepared in 10 mL of sterile deionized water and delivered by spraying the antimicrobial onto the surface of the inoculated meat while mixing in a Hobart mixer for 3 minutes to allow an even distribution of the antimicrobial on the meat surface. After mixing, inoculated treatments were portioned into sterile 13 oz. Whirl-Pak bags and stored at 15° C. The antimicrobial salts were added in various weight percentages. Weight percentages of the salts are based on the weight of the meat.

Triplicate samples of each treatment were assayed for either E. coli or Salmonella spp. at various time points starting after the overnight incubation at 4° C. and 7, 10 or 14 days after that, depending on the test. Bacterial populations were enumerated by homogenizing 25 g of inoculated sample with 50 ml Butterfields phosphate buffer in a stomacher (Lab-Blender 400, Cooke Laboratory Products, Alexandria, Va.) for 1-2 minutes. E. coli populations for each sample were enumerated by surface plating serial dilutions of homogenate on MacConkey agar with sorbitol (SMAC; 35° C., 48 h) whereas Salmonella populations were enumerated by surface plating on Xylose Lysine Deoxycholate agar (XLD; 35° C., 48 h).

FIG. 1 shows the result of a first experiment with minced meat inoculated with the above mentioned Salmonella spp. It shows the average change in the amount of bacteria on day 14 compared to the amount on the day after the overnight incubation at 4° C. (day 0). The results in FIG. 1 show:
untreated meat (control, white bar),
meat treated with 0.25 wt. % of sodium acetate/sodium diacetate, 80/20 weight ratio (0.25% sodium acetate/diacetate, vertical patterned bar),
meat treated with 0.25 wt. % of sodium propionate/sodium dipropionate, 80/20 weight ratio (0.25% sodium acetate/diacetate, diagonally patterned bar), and
meat treated with 0.25 wt. % of sodium propionate/sodium acetate, 80/20 weight ratio (0.25% sodium acetate/diacetate, black bar).

When the meat was treated with acetate salts or propionate salts alone in a concentration of 0.25 wt. % by weight of the meat a marked decrease of CFUs compared to day 0 can be observed in FIG. 1, whereas the control samples show an increase of bacterial population. This effect is almost twice as strong when a combination of acetate and propionate salts is used in a total concentration of 0.25 wt. % by weight of the meat.

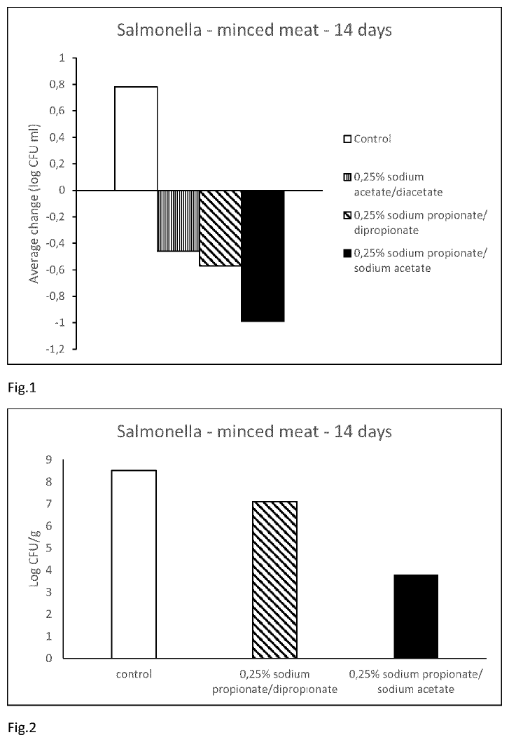

FIG. 2 shows the result of a second experiment with minced meat inoculated with the above mentioned Salmonella spp. It shows the amount of bacteria on day 14 after the overnight incubation at 4° C. The results in FIG. 2 show:
untreated meat (control, white bar),
meat treated with 0.25 wt. % of sodium propionate/sodium dipropionate, 80/20 weight ratio (0.25% sodium acetate/diacetate, diagonally patterned bar), and
meat treated with 0.25 wt. % of sodium propionate/sodium acetate, 80/20 weight ratio (0.25% sodium acetate/diacetate, black bar).

When the meat was treated with propionate salts alone in a concentration of 0.25 wt. % by weight of the meat markedly less bacteria were counted compared to the control samples. This effect is almost twice as strong when a combination of acetate and propionate salts was used in a total concentration of 0.25 wt. % by weight of the meat.

The experiments in FIGS. 1 and 2 demonstrate the synergistic effect of the combination of acetate and propionate salts in inhibiting growth of Salmonella in a meat product.

FIG. 3 shows the result of a first experiment with minced meat inoculated with the above mentioned E. coli mixture. It shows the average change in the amount of bacteria on day 10 compared to the amount on the day after the overnight incubation at 4° C. (day 0). The results in FIG. 3 show:
untreated meat (control, white bar),
meat treated with 0.5 wt. % of sodium acetate/sodium diacetate, 80/20 weight ratio (0.5% sodium acetate/20 diacetate, vertical patterned bar),
meat treated with 0.5 wt. % of sodium propionate/sodium dipropionate, 80/20 weight ratio (0.5% sodium acetate/diacetate, diagonally patterned bar), and
meat treated with 0.5 wt. % of sodium propionate/sodium acetate, 80/20 weight ratio (0.5% sodium acetate/diacetate, black bar).

When the meat was treated with acetate salts or propionate salts alone in a concentration of 0.5 wt. % by weight of the meat a marked decrease of CFUs compared to the control samples can be observed in FIG. 3. This effect is even stronger when a combination of acetate and propionate salts is used in a total concentration of 0.5 wt. % by weight of the meat.

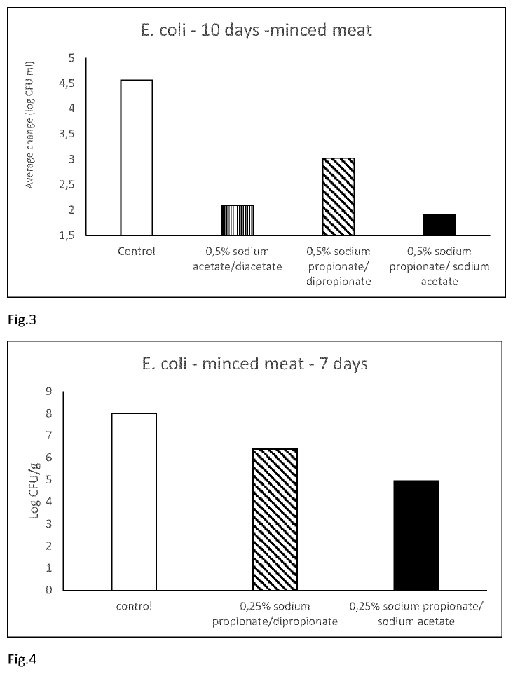

FIG. 4 shows the result of a second experiment with minced meat inoculated with the above mentioned E. coli mixture. It shows the amount of bacteria on day 7 after the overnight incubation at 4° C. The results in FIG. 4 show
untreated meat (control, white bar),
meat treated with 0.25 wt. % of sodium propionate/sodium dipropionate, 80/20 weight ratio (0.25% sodium acetate/diacetate, diagonally patterned bar), and
meat treated with 0.25 wt. % of sodium propionate/sodium acetate, 80/20 weight ratio (0.25% sodium acetate/diacetate, black bar).

When the meat was treated with propionate salts alone in a concentration of 0.25 wt. % by weight of the meat markedly less bacteria were counted compared to the control samples. This effect is much stronger when a combination of acetate and propionate salts was used in a total concentration of 0.25 wt. % by weight of the meat.

The experiments in FIGS. 3 and 4 demonstrates the synergistic effect of the combination of acetate and propionate salts in inhibiting growth of E. coli in a meat product.

### 2. Comparative Example—Listeria

Deli-style turkey slices were surface-inoculated with L. monocytogenes (a gram positive bacterium). Each package (approximately 4 slices) was inoculated using 0.5 ml inoculum distributed over one surface of each slice, and then stacked such that the inoculum was between the slices. Inoculated products were vacuum packaged (and stored at 7° C.). Triplicate inoculated samples were assayed for L. monocytogenes. Listeria inoculated samples stored at 7° C. were assayed at 7 weeks. Bacterial populations were enumerated on rinse material obtained by adding 100 ml of sterile Butterfield's phosphate buffer to each package and massaging the contents externally by hand for 2 minutes to release the cells from the slice surface3. L. monocytogenes populations for each sample were enumerated by surface plating serial dilutions of rinse material on MOX.

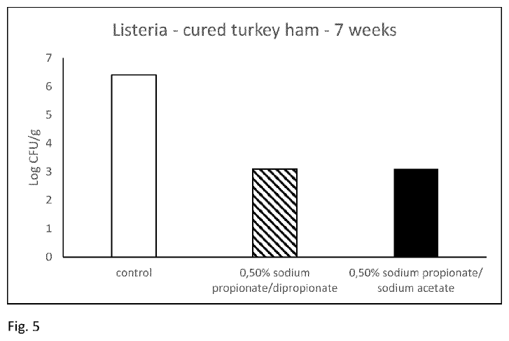

FIG. 5 shows the result of this experiment. It shows the amount of bacteria after 7 weeks of incubation at 7° C. The results in FIG. 5 show
untreated meat (control, white bar),
meat treated with 0.50 wt. % of sodium propionate/sodium dipropionate, 80/20 weight ratio (0.50% sodium acetate/diacetate, diagonally patterned bar), and
meat treated with 0.50 wt. % of sodium propionate/sodium acetate, 80/20 weight ratio (0.50% sodium acetate/diacetate, black bar).

When the meat was treated with propionate salts alone in a concentration of 0.50 wt. % by weight of the meat markedly less bacteria were counted compared to the control samples. This effect does not increase when a combination of acetate and propionate salts was used in a total concentration of 0.50 wt. % by weight of the meat.

This demonstrates that the synergistic effect of the combination of acetate and propionate salts is specific for gram negative bacteria.

1. Use of a combination of sodium salts of propionate and acetate for inhibiting growth of gram negative bacteria in or on a meat product; wherein said combination is provided as a powder composition comprising sodium salts of propionate and acetate.

2. Use according to claim 1, for inhibiting growth of gram negative bacteria of the Enterobacteriaceae family.

3. Use according to claim 1, for inhibiting growth of bacteria of the Salmonella genus.

4. Use according to claim 3, wherein the bacteria of the Salmonella genus comprise one or more of Salmonella enteritidis, Salmonella heidelberg, and Salmonella typhimurium.

5. Use according to claim 2, for inhibiting growth of Escherichia coli.

6. Use according to claim 1, wherein the meat product is a raw meat product.

7. Use according to claim 1, wherein said composition comprises no lactate salts.

8. Use according to claim 1, wherein said composition consists of sodium salts of propionate and acetate.

9. Use according to claim 1, wherein the weight ratio of propionate to acetate salts ranges from 10:90 to 90:10, preferably wherein the portion of propionate salts exceeds the portion of acetate salts in weight, such as a ratio between 50:50 to 90:10, with more preference wherein the weight ratio of propionate to acetate salts is about 80:20.

10. Method for inhibiting growth of gram-negative bacteria in or on a meat product, comprising
treating said meat product with a combination of sodium salts of propionate and acetate, wherein said combination is provided as a powder composition comprising sodium salts of propionate and acetate; and
testing for the presence of gram-negative bacteria in or on the meat product.

11. Method according to claim 10, wherein testing for the presence of gram-negative bacteria in or on the meat product comprises testing for the presence of bacteria of the Enterobacteriaceae family.

12. Method according to claim 11, wherein testing for the presence of gram-negative bacteria in or on the meat product comprises testing for the presence of bacteria of the Salmonella genus.

13. Method according to claim 12, wherein testing for the presence of bacteria of the Salmonella genus in or on the meat product comprises testing for the presence of one or more of Salmonella enteritidis, Salmonella heidelberg, and Salmonella typhimurium.

14. Method according to claim 11, wherein testing for the presence of bacteria of the Enterobacteriaceae family comprises testing for the presence of Escherichia coli.

15. Method according to claim 10, wherein the meat product is a raw meat product.

16. Method according to claim 10, wherein said composition comprises no lactate salts.

17. Method according to claim 16, wherein said composition consists of sodium salts of propionate and acetate.

18. Method according to claim 10, wherein treating said meat product comprises rubbing or mixing said combination of propionate and acetate salts into or on said meat product.

19. Method according to claim 10, wherein the weight ratio of propionate to acetate salts ranges from 10:90 to 90:10, preferably wherein the portion of propionate salts exceeds the portion of acetate salts in weight, such as a ratio between 50:50 to 90:10, with more preference wherein in the weight ratio of propionate to acetate salts is about 80:20.

20. Meat product, treated with a powder composition of sodium salts of propionate and acetate.

21. Meat product according claim 20, wherein the meat product is a raw meat product.

22. Meat product according claim 21, which is selected from the group consisting of fresh raw meat, such as minced meat, processed raw meat, mildly processed raw meat, unprocessed raw meat, fermented raw meat, such as fermented sausages.

23. Meat product according to claim 20, wherein said composition comprises no lactate salts.

24. Meat product according to claim 23, wherein said composition consists of sodium salts of propionate and acetate.

25. Meat product according to claim 21, wherein the weight ratio of propionate to acetate salts ranges from 10:90 to 90:10, preferably wherein the portion of propionate salts exceeds the portion of acetate salts in weight, such as a ratio between 50:50 to 90:10, with more preference wherein in the weight ratio of propionate to acetate salts is about 80:20.
